(19) United States
(12) Patent Application Publication
(10) Pub. No.: US 2007/0237265 A1
(43) Pub. Date: Oct. 11, 2007

(54) DEMODULATOR AND METHOD THEREOF

(76) Inventor: Hsiang-Hui Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/279,392

(22) Filed: Apr. 11, 2006

(51) Int. Cl. H04L 27/06

(52) U.S. Cl. 375/340

(57) ABSTRACT

Methods and apparatuses for demodulating an incoming signal are disclosed. A proposed demodulator includes: a first pulse generator for generating a first control signal according to an incoming signal; a second pulse generator coupled to the first pulse generator for generating a second control signal according to the incoming signal and the first control signal; and an output buffer coupled to the first pulse generator and the second pulse generator for generating an output signal under the control of the first and second control signals, wherein the magnitude of the output signal is clamped when the frequency of the incoming signal is lower than a predetermined threshold.

### BACKGROUND

The present invention relates to demodulators, and more particularly, to pulse count type demodulators.

A frequency modulation (FM) demodulator is an important component for an FM receiver. Typically, the FM demodulator is realized by a phase-locked loop (PLL), and a demodulated signal is obtained from the input of a VCO (voltage-controlled oscillator) of the PLL. In such a scheme, however, the linearity of the FM modulator is poor due to the frequency gain of the VCO not being linear.

Therefore, more and more FM receivers replace the PLL-based FM demodulators with pulse-count type FM demodulators since the pulse-count type FM demodulators are intrinsically linear. In the conventional pulse count type FM demodulator, linearity is maintained over a wide frequency band ranging from zero to 2 times an intermediate frequency (IF). Unfortunately, all frequency components located within such a frequency band, even the noise components, are treated as valid signals. As a result, the adjacent channel rejection (ACR) ability of the FM demodulator is deteriorated.

### SUMMARY

Therefore, it is an objective of the present disclosure to provide a demodulator having a higher ACR ability.

An exemplary embodiment of a demodulator is disclosed comprising: a first pulse generator for generating a first control signal according to an incoming signal; a second pulse generator coupled to the first pulse generator for generating a second control signal according to the incoming signal and the first control signal; and an output buffer coupled to the first pulse generator and the second pulse generator for generating an output signal under the control of the first and second control signals, wherein the magnitude of the output signal is clamped when the frequency of the incoming signal is lower than a predetermined threshold.

An exemplary embodiment of a method for demodulating an incoming signal is disclosed comprising: generating a first control signal according to the incoming signal; generating a second control signal according to the incoming signal and the first control signal; and generating an output signal according to the first and second control signals; wherein the magnitude of the output signal is clamped when the frequency of the incoming signal is lower than a predetermined threshold.

An exemplary embodiment of a demodulator is disclosed comprising: a first pulse generator for generating a first control signal according to an incoming signal; a second pulse generator coupled to the first pulse generator for generating a second control signal according to the incoming signal and the first control signal; and an output buffer coupled to the second pulse generator for generating an output signal according to the second control signal, wherein the magnitude of the output signal is determined by the pulse width of the second control signal.

An exemplary embodiment of a method for demodulating an incoming signal is disclosed comprising: generating a first control signal according to the incoming signal; generating a second control signal according to the incoming signal and the first control signal; and generating an output signal according to the second control signal, wherein the magnitude of the output signal is determined by the pulse width of the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an FM demodulator according to a first exemplary embodiment.

FIG. 2 is a differential architecture of an output buffer of FIG. 1 according to an exemplary embodiment.

FIG. 3 is a flowchart illustrating a method for demodulating an incoming signal according to a preferred embodiment.

FIG. 4 and FIG. 5 are timing diagrams illustrating operations of the FM demodulator of FIG. 1 with respect to different cases.

FIG. 6 is a schematic diagram of the difference between two differential signals generated by the output buffer of FIG. 2 for the case where the frequency of the incoming signal is lower than a lower limit.

FIG. 7 is a schematic diagram illustrating the frequency response of the FM demodulator of FIG. 1 according to an exemplary embodiment.

FIG. 8 is a single-ended form of the output buffer of FIG. 1 according to an exemplary embodiment.

FIG. 9 is a simplified block diagram of an FM demodulator according to a second exemplary embodiment.

FIG. 10 is a frequency response of the FM demodulator of FIG. 9 according to an exemplary embodiment.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

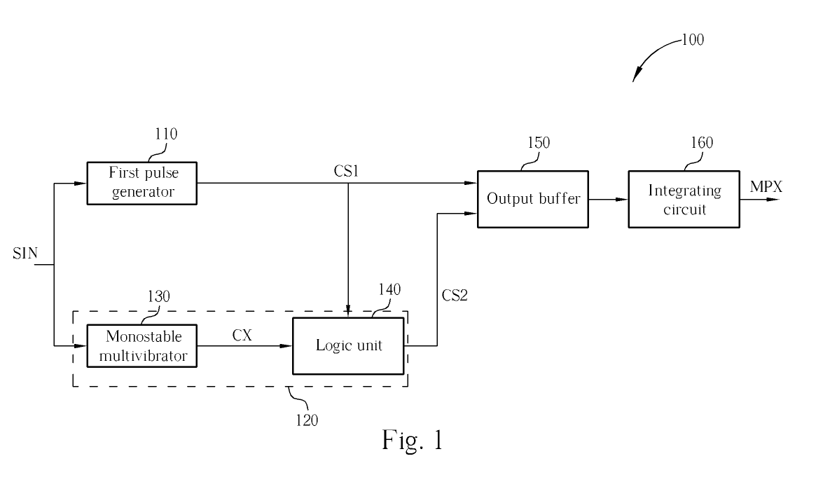

Please refer to FIG. 1, which shows a simplified block diagram of a demodulator 100 according to a first exemplary embodiment. In this embodiment, the demodulator 100 comprises: a first pulse generator 110; a second pulse generator 120 coupled to the first pulse generator 110; an output buffer 150 coupled to the first pulse generator 110 and the second pulse generator 120; and an integrating circuit 160 coupled to the output buffer 150. As shown in FIG. 1, an incoming signal SIN is processed by the first pulse generator 110 and the second pulse generator 120 in parallel. In a preferred embodiment, the incoming signal SIN is a frequency-modulated signal and the demodulator 100 is an FM demodulator, however this is merely an example and not a restriction of the practical applications.

In this embodiment, the first pulse generator 110 is realized by a monostable multivibrator with a first delay Td1 while the second pulse generator 120 is realized by another monostable multivibrator 130 with a second delay Td2 cooperating with a logic unit 140, wherein the second delay Td2 is greater than the first delay Td1. In operations, an intermediate frequency (IF) F_{IF} of the demodulator 100 is determined by the first delay Td1 while a lower limit F_{LOW} of the linear demodulating band of the demodulator 100 is determined by the second delay Td2. For example, Td1 is ½ F_{IF} while Td2 is ½ F_{LOW} in this embodiment.

In practice, the output buffer 150 may be designed to generate a single-ended output signal or two differential signals depending on the type of integrating circuit 160. In other words, the output buffer 150 may be a single-ended stage or a differential stage.

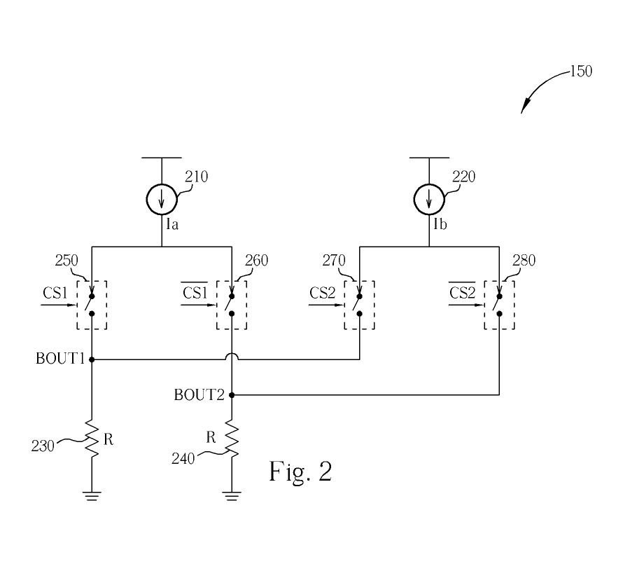

For example, FIG. 2 shows a differential embodiment of the output buffer 150. In this embodiment, the output buffer 150 comprises: a first current source 210; a second current source 220; a first resistor 230 having a first terminal, the first terminal being one of the differential output terminals of the output buffer 150, and a second terminal coupled to a predetermined voltage level; a second resistor 240 having a first terminal, the first terminal being another differential output terminal of the output buffer 150, and a second terminal coupled to a predetermined voltage level; a first switch 250 coupled between the first current source 210 and the first terminal of the first resistor 230; a second switch 260 coupled between the first current source 210 and the first terminal of the second resistor 240; a third switch 270 coupled between the second current source 220 and the first terminal of the first resistor 230; and a fourth switch 280 coupled between the second current source 220 and the second terminal of the second resistor 240. The first current source 210 is arranged for providing a first current Ia, and the second current source 220 is arranged for providing a second current Ib. In this embodiment, both the first and second resistors 230 and 240 have the same resistance R, and the second terminals of the first and second resistors 230 and 240 are both connected to the ground voltage level.

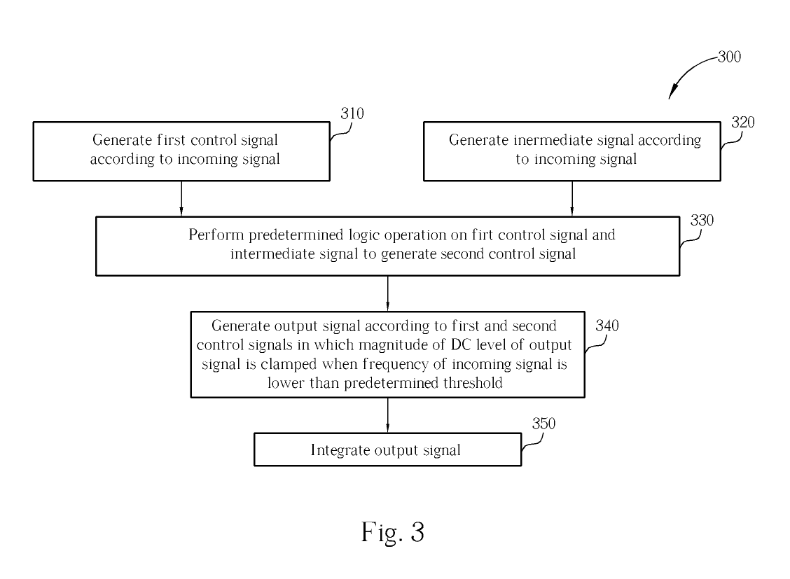

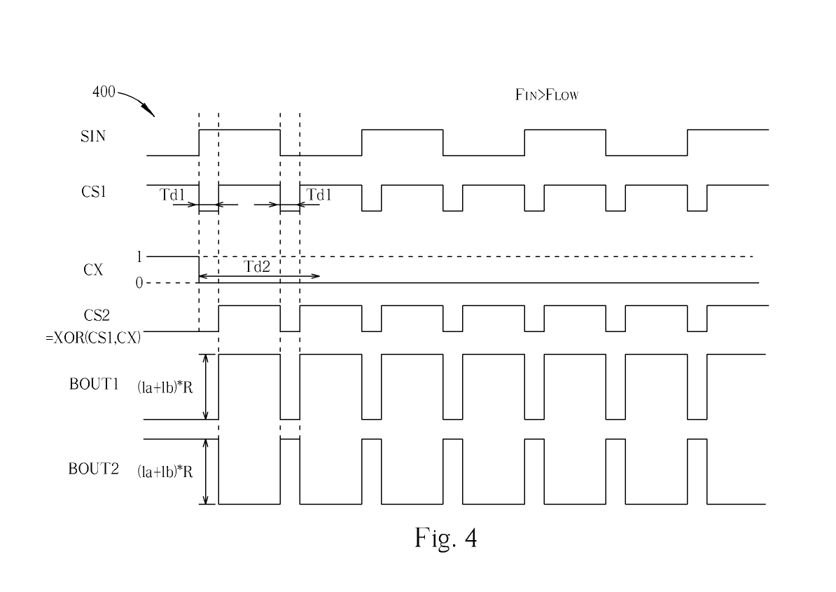

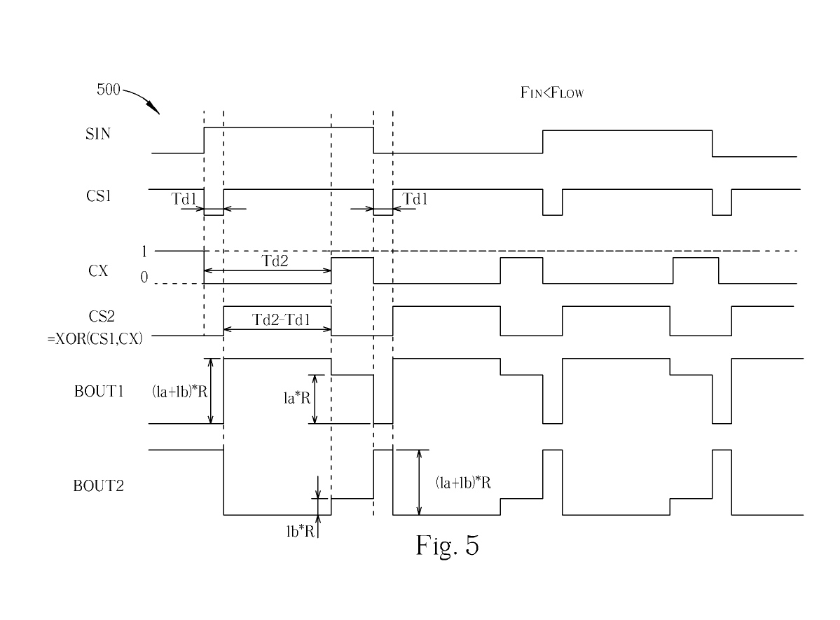

Hereinafter, operations of the demodulator 100 will be explained with reference to FIG. 3 through FIG. 5. FIG. 3 depicts a flowchart 300 illustrating a method for demodulating an incoming signal according to a preferred embodiment. FIG. 4 and FIG. 5 are timing diagrams 400 and 500 illustrating operations of the demodulator 100 with respect to different cases. Steps of the flowchart 300 are described below.

In step 310, the first pulse generator 110 generates a first control signals CS1 according to the incoming signal SIN. As shown in FIG. 4 and FIG. 5, the first pulse generator 110 switches the first control signal CS1 from a first logic level (e.g. logic 1 in this embodiment) to a second logic level (e.g. logic 0 in this case) at the transitions of the incoming signal SIN, and then switches the first control signal CS1 from the second logic level to the first logic level after the first delay Td1. As can be derived from the timing diagrams 400 and 500, the pulse width of the first control signal CS1 increases as a frequency F_{IN} of the incoming signal SIN decreases.

In step 320, the monostable multivibrator 130 of the second pulse generator 120 generates an intermediate signal CX according to the incoming signal SIN. As shown in FIG. 4, in the case where the frequency F_{IN} of the incoming signal SIN is higher than the lower limit F_{LOW} of the linear demodulating band of the demodulator 100, the second delay Td2 is greater than the pulse width of the incoming signal SIN. After the monostable multivibrator 130 switches the intermediate signal CX from a first logic level (e.g. logic 1 in this embodiment) to a second logic level (e.g. logic 0 in this case) at the first transition of the incoming signal SIN, the monostable multivibrator 130 resets the intermediate signal CX again at the next transition of the incoming signal SIN. Accordingly, the intermediate signal CX retains at the logic low state after the first transition of the incoming signal SIN. As shown in FIG. 5, in the case where the frequency F_{IN} of the incoming signal SIN is lower than the lower limit F_{LOW}, the second delay Td2 is less than the pulse width of the incoming signal SIN. The monostable multivibrator 130 switches the intermediate signal CX from logic 1 to logic 0 at the transitions of the incoming signal SIN, and then switches the intermediate signal CX from the second logic level to the first logic level after the second delay Td2. In such a scheme, the pulse width of the intermediate signal CX increases as the frequency F_{IN} decreases.

In step 330, the logic unit 140 of the second pulse generator 120 performs a predetermined logic operation on the first control signal CS1 and the intermediate signal CX to generate a second control signal CS2. In this embodiment, the logic unit 140 performs an XOR operation on the first control signal CS1 and the intermediate signal CX to generate the second control signal CS2. As illustrated in FIG. 4, in the case where the frequency F_{IN} of the incoming signal SIN is higher than the lower limit F_{LOW} of the linear demodulating band of the demodulator 100, the intermediate signal CX retains at the logic low state after the first transition of the incoming signal SIN. Thus, the waveform of the second control signal CS2 generated by performing the XOR operation on the first control signal CS1 and the intermediate signal CX is identical to the waveform of the first control signal CS1.

In the case where the frequency F_{IN} of the incoming signal SIN is lower than the lower limit F_{LOW} of the linear demodulating band of the demodulator 100, the waveform of the second control signal CS2 generated by the logic unit 140 is illustrated as shown in the timing diagram 500. As shown, the pulse width of the second control signal CS2 is fixed in Td2−Td1 when the frequency F_{IN} of the incoming signal SIN is lower than the lower limit F_{LOW}.

In step 340, the output buffer 150 generates an output signal under the control of the first control signal CS1 and the second control signal CS2 in which the magnitude of the output signal is clamped when the frequency F_{IN} of the incoming signal SIN is lower than the lower limit F_{LOW}. For the purpose of explanatory convenience in the following description, the output buffer 150 shown in FIG. 2 is herein taken as an example for describing the operation of step 340. In this embodiment, the output buffer 150 generates two differential signals BOUT1 and BOUT2 under the control of the first control signal CS1 and the second control signal CS2. As shown in FIG. 2, the first switch 250 of the output buffer 150 is controlled by the first control signal CS1; the second switch 260 is controlled by an inverted signal of the first control signal CS1; the third switch 270 is controlled by the second control signal CS2; and the fourth switch 280 is controlled by an inverted signal of the second control signal CS2.

As in the descriptions of step 330, when the frequency F_{IN} of the incoming signal SIN is higher than the lower limit F_{LOW}, the first control signal CS1 and the second control signal CS2 are identical. Therefore, the waveform of the differential signals BOUT1 and BOUT2 generated by the output buffer 150 are illustrated as shown in FIG. 4. In this scheme, the pulse width of the incoming signal SIN (or the frequency F_{IN}) has a linear relationship with the difference between the two differential signals BOUT1 and BOUT2. In other words, the demodulator 100 has a linear demodulating ability with respect to the frequency band ranging from the lower limit F_{LOW} to two times the intermediate frequency (IF) F_{IF} of the demodulator 100.

On the other hand, when the frequency F_{IN} of the incoming signal SIN is lower than the lower limit F_{LOW}, the pulse width of the first control signal CS1 increases as the frequency F_{IN} of the incoming signal SIN decreases, but the pulse width of the second control signal CS2 is fixed in Td2−Td1. As a result, the waveform of the differential signals BOUT1 and BOUT2 generated by the output buffer 150 are illustrated as shown in FIG. 5.

In order to improve the ACR (adjacent channel rejection) ability of the demodulator 100, frequency components of the incoming signal SIN that are lower than the lower limit F_{LOW} should not be demodulated by the demodulator 100. That is, the magnitude of the output signal generated by the output buffer 150 should be clamped at a fixed level when the frequency F_{IN} of the incoming signal SIN is lower than the lower limit F_{LOW}. In this embodiment, since the output buffer 150 is a differential stage buffer, the magnitude of the difference between the two differential signals BOUT1 and BOUT2 generated by the output buffer 150 should be clamped when the frequency F_{IN} is lower than the lower limit F_{LOW}.

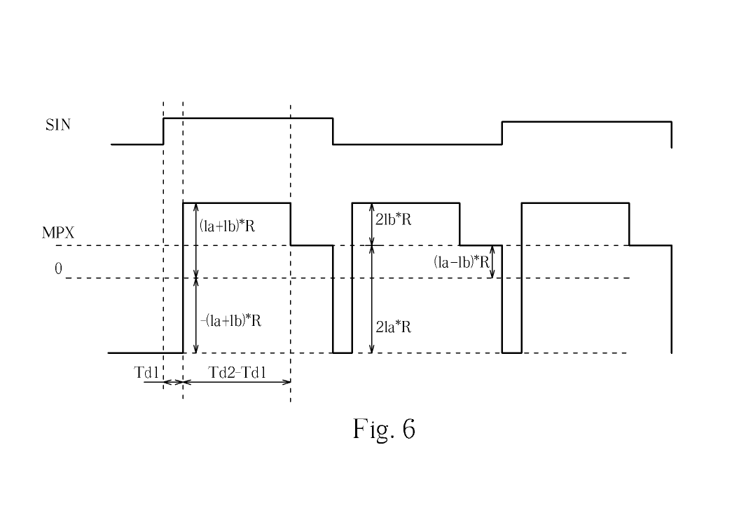

FIG. 6 illustrates a schematic diagram of the difference between the two differential signals BOUT1 and BOUT2 generated by the output buffer 150 for the case where the frequency F_{IN} is lower than the lower limit F_{LOW}. According to the illustrations, it can be appreciated that the magnitude of the difference between the two differential signals BOUT1 and BOUT2 is determined by the pulse width of both the first and second control signals CS1 and CS2. To clamp the magnitude of the difference between the two differential signals BOUT1 and BOUT2 when the frequency F_{IN} is lower than the lower limit F_{LOW}, the first delay Td1, the second delay Td2, the first current source 210 and the second current source 220 of the output buffer 150 can be designed to satisfy the following formula:
Td1*Ia=(Td2−Td1)*Ib (1)

where Ia is the current provided by the first current source 210, and Ib is the current provided by the second current source 220. As can be seen in FIG. 6, if Td1, Td2, Ia, and Ib satisfy the formula (1), the magnitude of the difference between the two differential signals BOUT1 and BOUT2 can be clamped at a fixed level when the frequency F_{IN} is lower than the lower limit F_{LOW}. Consequently, frequency components of the incoming signal SIN that are lower than the lower limit F_{LOW}, are not demodulated by the demodulator 100, thereby significantly improving the ACR ability of the demodulator 100.

Then, the integrating circuit 160 integrates the output signal to generate a demodulated signal MPX in step 350. Since the output buffer 150 of this embodiment is a differential stage, the integrating circuit 160 is also a differential stage, such as a differential low-pass filter.

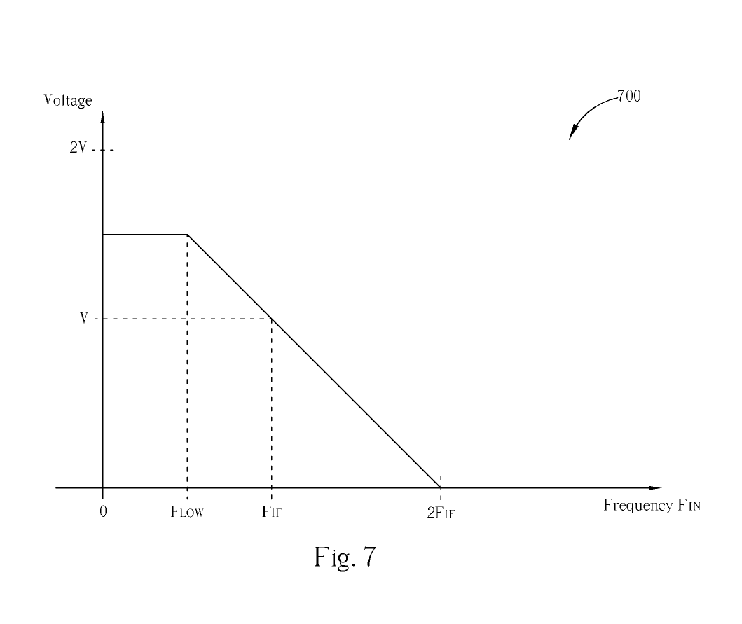

FIG. 7 shows a schematic diagram illustrating the frequency response 700 of the demodulator 100 according to an exemplary embodiment. As shown, if the frequency F_{IN} of the incoming signal SIN is higher than the lower limit F_{LOW}, the DC magnitude of the output of the demodulator 100 has a linear relationship with the frequency F_{IN} of the incoming signal SIN, i.e. the demodulating operation of the demodulator 100 is linear. On the other hand, if the frequency F_{IN} of the incoming signal SIN is lower than the lower limit F_{LOW}, the DC magnitude of the output of the demodulator 100 is clamped. Accordingly, the demodulator 100 of this embodiment has a linear demodulating band ranging from the lower limit F_{LOW} to 2 F_{IF}.

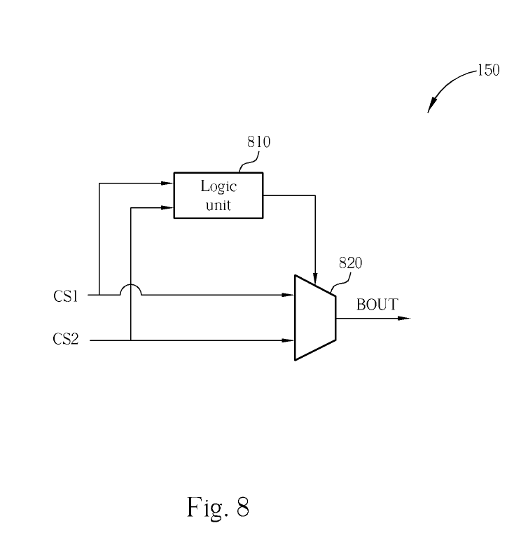

Please refer to FIG. 8, which shows a single-ended embodiment of the output buffer 150. In this embodiment, the output buffer 150 comprises a logic unit 810 and a selector 820. The logic unit 810 is arranged for comparing the waveform of the first control signal CS1 and the second control signal CS2. The selector 820 is arranged for outputting either the first control signal CS1 or the second control signal CS2 as an output signal BOUT. As described previously, the first control signal CS1 and the second control signal CS2 are identical when the frequency F_{IN} of the incoming signal SIN is higher than the lower limit F_{LOW}. Conversely, the first control signal CS1 and the second control signal CS2 are not identical when the frequency F_{IN} of the incoming signal SIN is lower than the lower limit F_{LOW}. Therefore, the logic unit 810 may be implemented with an XOR gate, which outputs logic 0 when the first control signal CS1 is identical to the second control signal CS2, and outputs logic 1 when they are not identical. In this case, the selector 820 selects the first control signal CS1 as the output signal BOUT when the output of the logic unit 810 is at logic 0, and selects the second control signal CS2 as the output signal BOUT when the output of the logic unit 810 is at logic 1.

When the frequency F_{IN} of the incoming signal SIN is lower than the lower limit F_{LOW}, since the pulse width of the second control signal CS2 is limited to be Td2−Td1, the magnitude of the output signal BOUT generated by the output buffer 150 is clamped at a certain level as well as in the aforementioned embodiment. In practice, the output buffer 150 can also generate the output signal BOUT according to the second control signal CS2 only. In such a scheme, the magnitudes of the output signal BOUT generated by the output buffer 150 is determined by the pulse width of the second control signal CS2.

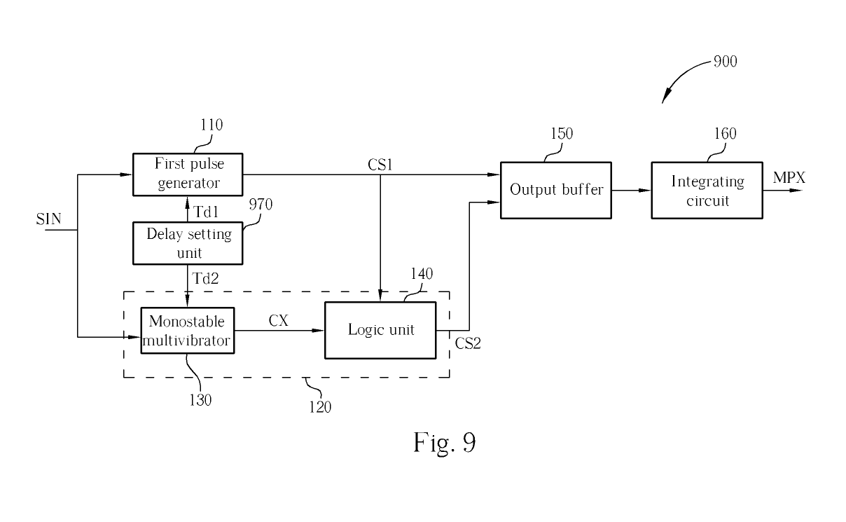

FIG. 9 illustrates a simplified block diagram of a demodulator 900 according to a second exemplary embodiment. The demodulator 900 is similar to the demodulator 100 described above, and components having substantially the same operations and implementations are labeled the same for the sake of clarity. A difference between the demodulator 900 and the demodulator 100 is that a delay setting unit 970 is arranged in the demodulator 900. In practice, the delay setting unit 970 may be coupled to at least one of the first pulse generator 110 and the second pulse generator 120 for programming the delay of the coupled delay device. For example, in the embodiment shown in FIG. 9, the delay setting unit 970 is coupled to both the first and second pulse generator 110 and 120 for programming the first delay Td1 and the second delay Td2. As well as the demodulator 100 described above, the intermediate frequency F_{IF} of the demodulator 900 is determined by the first delay Td1, and the lower limit F_{LOW} of the linear demodulating band of the demodulator 900 is determined by the second delay Td2. Accordingly, the delay setting unit 970 can adjust the linear demodulating band of the demodulator 900 by changing the first delay Td1 and/or the second delay Td2.

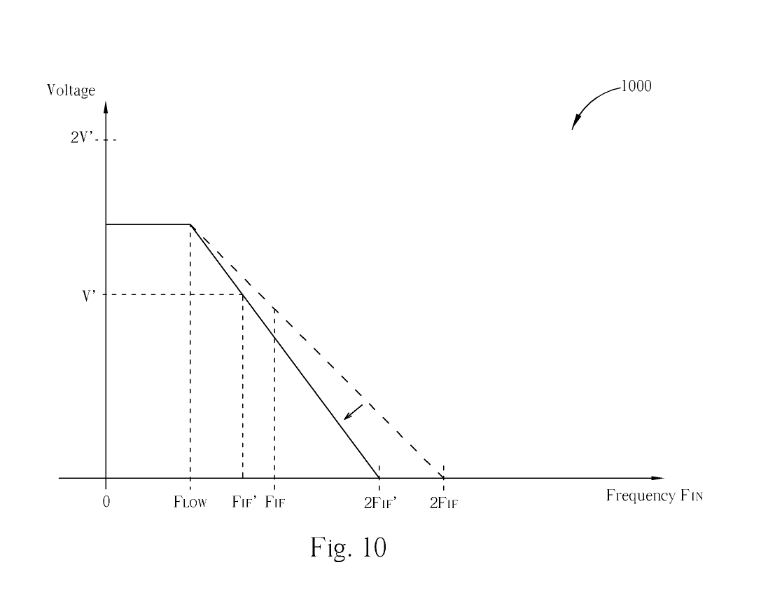

By way of example, FIG. 10 shows a frequency response 1000 of the demodulator 900 according to an exemplary embodiment. In this embodiment, the delay setting unit 970 increases the first delay Td1, so the intermediate frequency of the demodulator 900 is reduced from F_{IF} to F_{IF}′. As a result, the linear demodulating band of the demodulator 900 is adjusted to become a band ranging from the lower limit F_{LOW} to 2F_{IF}′. In contrast to the related art, the demodulator 900 provides more flexibility for the system designer to configure a desired linear demodulating band according to the system requirements.

Those skilled in the art will readily observe that numerous modifications and alterations of the device and method may be made while retaining the teachings of the invention. Accordingly, the above disclosure should be construed as limited only by the metes and bounds of the appended claims.

1. A demodulator comprising:
a first pulse generator for generating a first control signal according to an incoming signal;
a second pulse generator coupled to the first pulse generator for generating a second control signal according to the incoming signal and the first control signal; and
an output buffer coupled to the first pulse generator and the second pulse generator for generating an output signal under the control of the first and second control signals, wherein the magnitude of the output signal is clamped when the frequency of the incoming signal is lower than a predetermined threshold.

2. The demodulator of claim 1, wherein the first pulse generator is a first monostable multivibrator with a first delay.

3. The demodulator of claim 2, wherein the second pulse generator comprises:
a second monostable multivibrator with a second delay for generating an intermediate signal according to the incoming signal; and
a logic unit coupled to the second monostable multivibrator and the first pulse generator for performing a predetermined logic operation on the first control signal and the intermediate signal to generate the second control signal.

4. The demodulator of claim 3, wherein the first delay differs from the second delay.

5. The demodulator of claim 4, wherein the predetermined threshold is determined by the second delay.

6. The demodulator of claim 5, further comprising:
a delay setting unit coupled to the second monostable multivibrator for programming the second delay.

7. The demodulator of claim 6, wherein the delay setting unit is further coupled to the first monostable multivibrator for programming the first delay.

8. The demodulator of claim 3, wherein the output buffer is a differential stage, and the output signal is formed by two differential signals.

9. The demodulator of claim 8, further comprising:
a differential integrating circuit coupled to the output buffer for integrating the output signal.

10. The demodulator of claim 9, wherein the differential integrating circuit is a differential low-pass filter.

11. The demodulator of claim 8, wherein the output buffer comprises:
a first current source for providing a first current;
a second current source for providing a second current;
a first resistor having a first terminal being employed as one of the differential output terminals of the output buffer and a second terminal coupled to a predetermined voltage level;
a second resistor having a first terminal being employed as the other of the differential output terminals of the output buffer and a second terminal coupled to a predetermined voltage level;
a first switch coupled between the first current source and the first terminal of the first resistor in which the first switch is controlled by the first control signal;
a second switch coupled between the first current source and the first terminal of the second resistor in which the second switch is controlled by an inverted signal of the first control signal;
a third switch coupled between the second current source and the first terminal of the first resistor in which the third switch is controlled by the second control signal; and
a fourth switch coupled between the second current source and the first terminal of the second resistor in which the fourth switch is controlled by an inverted signal of the second control signal.

12. The demodulator of claim 11, wherein both the first and second resistors have the same resistance, the second terminals of the first and second resistors are both connected to the same voltage level, and the first and second currents satisfy the following formula:
Td1*Ia=(Td2−Td1)*Ib
where Td1 is the first delay, Td2 is the second delay, Ia is the first current, and Ib is the second current.

13. The demodulator of claim 3, wherein pulse width of the second control signal is determined by a difference between the first delay and the second delay when the frequency of the incoming signal is lower than the predetermined threshold.

14. The demodulator of claim 1, wherein the output buffer is a single-ended stage and the demodulator further comprises an integrating circuit coupled to the output buffer for integrating the output signal.

15. The demodulator of claim 14, wherein the integrating circuit is a single-ended low-pass filter.

16. The demodulator of claim 1, wherein the incoming signal is a frequency-modulated signal.

17. A method for demodulating an incoming signal, comprising:
generating a first control signal according to the incoming signal;
generating a second control signal according to the incoming signal and the first control signal; and
generating an output signal according to the first and second control signals;
wherein the magnitude of the output signal is clamped when the frequency of the incoming signal is lower than a predetermined threshold.

18. The method of claim 17, wherein the step of generating the first control signal comprises:
providing a first monostable multivibrator with a first delay; and
utilizing the first monostable multivibrator to generate the first control signal according to the incoming signal.

19. The method of claim 18, wherein the step of generating the second control signal comprises:
providing a second monostable multivibrator with a second delay;
utilizing the second monostable multivibrator to generate an intermediate signal according to the incoming signal; and
performing a predetermined logic operation on the first control signal and the intermediate signal to generate the second control signal.

20. The method of claim 19, wherein the first delay differs from the second delay.

21. The method of claim 20, wherein the predetermined threshold is determined by the second delay.

22. The method of claim 21, further comprising:
programming the second delay.

23. The method of claim 22, further comprising:
programming the first delay.

24. The method of claim 19, wherein the output signal is formed by two differential signals.

25. The method of claim 24, further comprising:
integrating the output signal.

26. The method of claim 25, further comprising:
integrating the output signal by performing a differential low-pass filtering operation on the output signal.

27. The method of claim 24, wherein the step of generating the output signal comprises:
providing a first current;
providing a second current;
providing a first resistor having a first terminal being employed for providing one of the differential signals and a second terminal coupled to a predetermined voltage level;
providing a second resistor having a first terminal being employed for providing another one of the differential signals and a second terminal coupled to a predetermined voltage level;
coupling the first current to either the first terminal of the first resistor or the first terminal of the second resistor according to the first control signal; and
coupling the second current to either the first terminal of the first resistor or the first terminal of the second resistor according to the second control signal.

28. The method of claim 27, wherein both the first and second resistors have the same resistance, the second terminals of the first and second resistors are both connected to the same voltage level, and the first and second currents satisfy the following formula:
Td1*Ia=(Td2−Td1)*Ib
where Td1 is the first delay, Td2 is the second delay, Ia is the first current, and Ib is the second current.

29. The method of claim 19, wherein pulse width of the second control signal is determined by a difference between the first delay and the second delay when the frequency of the incoming signal is lower than the predetermined threshold.

30. The method of claim 17, further comprising:
performing a low-pass filtering operation on the output signal to integrate the output signal.

31. The method of claim 17, wherein the incoming signal is a frequency-modulated signal.

32. A demodulator comprising:
a first pulse generator for generating a first control signal according to an incoming signal;
a second pulse generator coupled to the first pulse generator for generating a second control signal according to the incoming signal and the first control signal; and
an output buffer coupled to the second pulse generator for generating an output signal according to the second control signal, wherein the magnitude of the output signal is determined by the pulse width of the second control signal.

33. A method for demodulating an incoming signal, comprising:
generating a first control signal according to the incoming signal;
generating a second control signal according to the incoming signal and the first control signal; and
generating an output signal according to the second control signal, wherein the magnitude of the output signal is determined by the pulse width of the second control signal.
